(19) United States
(12) Patent Application Publication
(10) Pub. No.: US 2015/0351159 A1
(43) Pub. Date: Dec. 3, 2015

(54) CARBON HEATER, HEATER UNIT, FIRING FURNACE, AND METHOD FOR MANUFACTURING SILICON-CONTAINING POROUS CERAMIC FIRED BODY

(71) Applicant: IBIDEN CO., LTD., Ogaki-shi (JP)

(72) Inventors: Hiromichi KAMIJO, Ibi-gun (JP); Tadafumi OHASHI, Ibi-gun (JP); Takamitsu SAIJO, Ibi-gun (JP)

(73) Assignee: IBIDEN CO., LTD., Ogaki-shi (JP)

(21) Appl. No.: 14/724,821

(22) Filed: May 29, 2015

(30) Foreign Application Priority Data
Jun. 3, 2014 (JP) 2014-115128

(51) Int. Cl. H05B 3/14; F27D 11/02; F27D 3/00

(52) U.S. Cl. CPC H05B 3/145; F27D 3/0021; F27D 11/02

(57) ABSTRACT

A carbon heater to fire a silicon-containing material in a non-oxidizing atmosphere includes a cross-sectional shape of a substantially n-sided polygon, and n represents any one of 3 to 8.

### CROSS-REFERENCE TO RELATED APPLICATIONS

The present application claims priority under 35 U.S.C. §119 to Japanese Patent Application No. 2014-115128, filed Jun. 3, 2014. The contents of this application are incorporated herein by reference in their entirety.

### BACKGROUND OF THE INVENTION

1. Field of the Invention

The present invention relates to a carbon heater, a heater unit, a firing furnace, and a method for manufacturing a silicon-containing porous ceramic fired body.

2. Discussion of the Background

In recent years, particulate matter in exhaust gases discharged from internal combustion engines of vehicles such as buses and trucks, and construction machines, for example, has been a problem as it is harmful to the environment and the human body. Therefore, various particulate filters have been developed which capture particulate matter in exhaust gases and purify the exhaust gases with a honeycomb structured body made of porous ceramic.

Such a honeycomb structured body used includes rectangular pillar-shaped honeycomb fired bodies bonded with adhesive layers therebetween, each rectangular pillar-shaped honeycomb fired body produced by extrusion molding a mixture containing materials such as ceramic materials (e.g. silicon carbide), degreasing the molded body, and firing the degreased body, for example.

Generally, a honeycomb fired body is manufactured by firing, in a firing furnace, a honeycomb molded body produced by molding ceramic materials. One example of the firing furnace is disclosed in WO 2006/013931.

### SUMMARY OF THE INVENTION

According to one aspect of the present invention, a carbon heater to fire a silicon-containing material in a non-oxidizing atmosphere includes a cross-sectional shape of a substantially n-sided polygon, and n represents any one of 3 to 8.

According to another aspect of the present invention, a heater unit to fire a silicon-containing material in a non-oxidizing atmosphere includes a power source and a carbon heater. The carbon heater is connected to the power source. The carbon heater has a cross-sectional shape of a substantially n-sided polygon, and n represents any one of 3 to 8.

According to further aspect of the present invention, a firing furnace to fire a silicon-containing material in a non-oxidizing atmosphere includes a power source, a housing, a firing chamber, and a carbon heater. The firing chamber is arranged in the housing. The carbon heater is arranged in the housing and connected to the power source. The carbon heater has a cross-sectional shape of a substantially n-sided polygon, and n represents any one of 3 to 8.

According to the other aspect of the present invention, a method for manufacturing a silicon-containing porous ceramic fired body includes producing an object to be fired from a composition that contains a silicon-containing ceramic powder. The object to be fired is fired in a non-oxidizing atmosphere in a firing furnace. The firing furnace includes a power source, a housing, a firing chamber, and a carbon heater. The firing chamber is arranged in the housing. The carbon heater is arranged in the housing and connected to the power source. The carbon heater has a cross-sectional shape of a substantially n-sided polygon, and n represents any one of 3 to 8.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1A is a perspective view schematically illustrating one example of the carbon heater of an embodiment of the present invention, and FIG. 1B is an A-A line cross-sectional view of FIG. 1A.

FIG. 2A is a cross-sectional view schematically illustrating another example of the carbon heater of the embodiment of the present invention; FIG. 2B is a cross-sectional view schematically illustrating yet another example of the carbon heater of the embodiment of the present invention; and FIG. 2C is a cross-sectional view schematically illustrating yet another example of the carbon heater of the embodiment of the present invention.

FIG. 3 is a cross-sectional view schematically illustrating one example of a cold isostatic pressing apparatus.

FIG. 4 is a cross-sectional view schematically illustrating the inside of the firing furnace of the embodiment of the present invention.

FIG. 5 is a front view schematically illustrating one example of a continuous firing furnace.

FIG. 6 is a B-B line cross-sectional view of a high-temperature firing section of the continuous firing furnace illustrated in FIG. 5.

FIG. 7A is a perspective view schematically illustrating one example of a honeycomb fired body, and FIG. 7B is a D-D line cross-sectional view of FIG. 7A.

FIG. 8 is a perspective view schematically illustrating one example of a honeycomb structured body.

### DESCRIPTION OF THE EMBODIMENTS

The embodiments will now be described with reference to the accompanying drawings, wherein like reference numerals designate corresponding or identical elements throughout the various drawings.

When a honeycomb molded body made of a silicon-containing ceramic is fired in a firing furnace disclosed in WO 2006/013931, SiO gas generated in the firing causes silicification of carbon in the heater (reacts with carbon to form SiC). The silicification of carbon in the heater leads to evaporation of SiC from the surface of the heater, thereby causing the heater to break because of degradation.

Even if the heater does not break, the cross-sectional area of the heater decreases to raise a problem that maintaining the firing furnace at a constant temperature is difficult.

Although the mechanism that causes silicification on the surface of the heater has not been clarified, silicification is presumed to occur on the surface of the heater when Si gas and SiO gas are ionized by thermal electrons emitted by the heater (a phenomenon called the Edison effect), and the ionized SiO gas reacts with carbon in the heater. The mechanism is described in detail below.

The silicification is presumed to occur when SiO gas is ionized by thermal electrons by either one of the following two mechanisms.

The first mechanism is that thermal electrons are attached to SiO gas to ionize the SiO gas (following formula (I)). The resulting SiO⁻ ions are attracted to the charged heater and react with carbon, causing silicification on the surface of the heater.

The second mechanism is that the energy (E) of the thermal electrons is given to Si gas present at high temperatures, and Si⁺ ions are generated (following formula (II)). The Si⁺ ions are attracted to the heater and react with carbon, causing silicification on the surface of the heater.

SiO+e⁻→SiO⁻ (I)

Si+E→Si⁺+e⁻ (II)

The carbon heater of an embodiment of the present invention is a carbon heater used to fire a silicon-containing material in a non-oxidizing atmosphere, including a cross-sectional shape of a substantially n-sided polygon, wherein n represents any one of 3 to 8.

A carbon heater having a cross-sectional shape of a substantially n-sided polygon has a longer peripheral length (larger surface area) than a carbon heater having a cross-sectional shape of a circle and having the same cross-sectional area.

The increase in the surface area of the carbon heater inhibits the carbon heater from emitting thermal electrons for the following reasons.

As shown by the relational expression (following equation (III)) of thermal radiation, if the heat quantity Q to be generated is constant, the increase in the surface area S of the carbon heater leads to a decrease in the temperature T of the surface of the carbon heater.

Q=eσSt(T⁴−Ts⁴) (III)

In the equation, Q represents the amount of heat [J] radiated by the carbon heater; e represents radiation efficiency which, in the case of carbon, is about 0.9; σ represents the Stefan-Boltzmann constant [5.67×10⁻⁸ W·m⁻²·K⁻⁴]; S represents the surface area [m²] of the carbon heater; t represents radiation time [t]; T represents the temperature [K] of the surface of the carbon heater; and Ts represents the surrounding temperature [K].

The decrease in the temperature of the surface of the carbon heater inhibits emission of thermal electrons as shown by the Richardson-Dushman equation (following equation (IV)).

I=AT²exp(−φ/kT) (IV)

In the equation, I represents the current density [A/cm²] of the thermal electrons; T represents the temperature [K] of the surface of the carbon heater; A represents the emission constant (the Richardson constant); φ represents the work function; and k represents Boltzmann's constants [8.62×10⁻⁵ eV·K⁻¹].

As is clear from the above equation (IV), the increase in the surface area of the carbon heater inhibits emission of thermal electrons. As a result, SiO gas is not likely to be ionized, and thus silicification on the surface of the carbon heater can be inhibited.

Since the carbon heater of the embodiment of the present invention can inhibit emission of thermal electrons as described above, silicification on the surface of the carbon heater by SiO gas can be inhibited.

In the carbon heater of the embodiment of the present invention, n is any one of 3 to 8, more preferably any one of 3 to 6, and still more preferably 3 or 4.

As n decreases, the surface area of the carbon heater designed to have the same cross-sectional area increases. That is, with a smaller value of n, emission of thermal electrons can be more inhibited.

If n is greater than 8, the surface area of the carbon heater is small, and thus emission of thermal electrons cannot be sufficiently inhibited.

The substantially n-sided polygon herein includes an equilateral n-sided polygon, an n-sided polygon, and a shape having a straight portion or a curved portion obtained by chamfering in at least one corner portion of any of these polygons.

The cross-sectional shape of the carbon heater of the embodiment of the present invention is preferably an equilateral n-sided polygon, an n-sided polygon, or a shape having a straight portion and/or a curved portion obtained by chamfering in at least one corner portion of any of these polygons.

In the case of forming a straight portion by chamfering in a corner portion of an equilateral n-sided polygon or an n-sided polygon, the length of the straight portion is 1 to 10 mm. In the case of forming a curved portion by chamfering, the radius of curvature of the curved portion is 1 to 10 mm. When the length of a straight portion or the radius of curvature of a curved portion after chamfering is longer than the upper limit of the corresponding range, the surface area of the carbon heater is likely to be excessively small.

The radius of curvature of a curved portion refers to the radius of an approximate circle obtained by approximating the curved portion formed by chamfering to a circle.

The carbon heater of the embodiment of the present invention is preferably chamfered.

Chamfering the carbon heater enables enhancement of the mechanical strength and processability of the carbon heater.

Also, making the angle of the corner portion larger or rounding the corner portion by chamfering enables reduction in the concentration of electric lines of force and prevention of discharge from the carbon heater.

Herein, the cross-sectional shape of the carbon heater is described without consideration of the surfaces and curved surfaces obtained by chamfering, and chamfering is not mentioned. That is, for example, if all the four corners of a carbon heater having a substantially quadrangular cross-sectional shape are chamfered, the resulting carbon heater is still described to have a substantially quadrangular cross-sectional shape.

In the carbon heater of the embodiment of the present invention, the chamfering is preferably performed to form a curved portion having a radius of curvature of 1 to 10 mm in a corner portion of a cross section perpendicular to the longitudinal direction.

If the radius of curvature of the curved portion formed in the corner portion of a cross section perpendicular to the longitudinal direction of the carbon heater is shorter than 1 mm, enhancement of the mechanical strength and processability is insufficient, and discharge from the carbon heater cannot be sufficiently prevented. If the radius of curvature of the curved portion formed in the corner portion of a cross section perpendicular to the longitudinal direction of the carbon heater is longer than 10 mm, the surface area of the carbon heater is small, and emission of thermal electrons cannot be sufficiently prevented.

In the carbon heater of the embodiment of the present invention, the chamfering is preferably performed to form a straight portion having a length of 1 to 10 mm in a corner portion of a cross section perpendicular to the longitudinal direction.

If the length of the straight portion formed in the corner portion of a cross section perpendicular to the longitudinal direction of the carbon heater is shorter than 1 mm, enhancement of the mechanical strength and processability is insufficient, and discharge from the carbon heater cannot be sufficiently prevented. If the length of the straight portion formed in the corner portion of a cross section perpendicular to the longitudinal direction of the carbon heater is longer than 10 mm, the surface area of the carbon heater is small, and emission of thermal electrons cannot be sufficiently prevented.

The carbon heater of the embodiment of the present invention preferably has an electrical resistance of 0.003 to 0.03Ω. If the electrical resistance of the carbon heater is lower than 0.003Ω, the electric power required for heating is likely to be excessively large. If the electrical resistance of the carbon heater is higher than 0.03Ω, sufficient electrical current does not flow in the carbon heater, and thus the carbon heater cannot be sufficiently heated.

The carbon heater of the embodiment of the present invention preferably has a cross-sectional area of 300 to 3000 mm².

If the cross-sectional area of the carbon heater is smaller than 300 mm², the electrical resistance of the carbon heater shows a relative increase. Therefore, sufficient electrical current does not flow in the carbon heater, and thus the carbon heater cannot be sufficiently heated. If the cross-sectional area is larger than 3000 mm², the electrical resistance of the carbon heater shows a relative decrease. Therefore, the electric power required for heating is likely to be excessively large.

The carbon heater of the embodiment of the present invention preferably has a density 1.50 to 2.00 g/cm³, more preferably 1.70 to 1.90 g/cm³, and still more preferably 1.75 to 1.88 g/cm³.

If the density of the carbon heater is lower than 1.50 g/cm³, the mechanical strength of the carbon heater may be insufficient, while if the density of the carbon heater is higher than 2.00 g/cm³, the manufacturing cost may increase.

The carbon heater of the embodiment of the present invention preferably has a porosity of 5 to 30%, more preferably 5 to 25%, and still more preferably 10 to 20%.

If the porosity of the carbon heater is lower than 5%, the yield of the products may decrease for the reasons related to the manufacturing method. If the porosity is higher than 30%, corrosion of the surface by high-temperature gas is likely to be promoted, and the carbon heater may be eroded in a short time to be unusable.

The heater unit of the embodiment of the present invention is a heater unit used to fire a silicon-containing material in a non-oxidizing atmosphere, including a power source, and a carbon heater connected to the power source, the carbon heater having a cross-sectional shape of a substantially n-sided polygon, wherein n represents any one of 3 to 8.

Since the heater unit utilizes a carbon heater that has a cross-sectional shape of a substantially n-sided polygon, wherein n represents any one of 3 to 8, degradation of the carbon heater can be inhibited, and the life of the carbon heater is thereby lengthened.

Preferably, the carbon heater constituting the heater unit of the embodiment of the present invention has a cross-sectional shape of an equilateral n-sided polygon, an n-sided polygon, or a shape having a straight portion and/or a curved portion obtained by chamfering in at least one corner portion of any of these polygons.

The firing furnace of the embodiment of the present invention is a firing furnace used to fire a silicon-containing material in a non-oxidizing atmosphere, including: a power source; a housing; a firing chamber arranged in the housing; and a carbon heater that is arranged in the housing and connected to the power source, the carbon heater having a cross-sectional shape of a substantially n-sided polygon, wherein n represents any one of 3 to 8.

Since the firing furnace of the embodiment of the present invention utilizes a carbon heater that has a cross-sectional shape of a substantially n-sided polygon, wherein n represents any one of 3 to 8, degradation of the carbon heater can be inhibited, and the life of the carbon heater is thereby lengthened.

Preferably, the carbon heater constituting the firing furnace of the embodiment of the present invention has a cross-sectional shape of an equilateral n-sided polygon, an n-sided polygon, or a shape having a straight portion and/or a curved portion obtained by chamfering in at least one corner portion of any of these polygons.

The method for manufacturing a silicon-containing porous ceramic fired body according to the embodiment of the present invention includes the steps of: producing an object to be fired from a composition that contains a silicon-containing ceramic powder; and firing the object to be fired in a non-oxidizing atmosphere in a firing furnace that includes: a power source; a housing; a firing chamber arranged in the housing; and a carbon heater that is arranged in the housing and connected to the power source, the carbon heater having a cross-sectional shape of a substantially n-sided polygon, wherein n represents any one of 3 to 8.

Since the carbon heater used as a heat generating element in the silicon-containing porous ceramic fired body of the embodiment of the present invention has a cross-sectional shape of a substantially n-sided polygon, degradation of the carbon heater can be inhibited, and the life of the carbon heater is thereby lengthened. This results in a lengthened carbon heater replacement period, enabling manufacture of a silicon-containing porous ceramic fired body at a low cost.

Preferably, the carbon heater used in the method for manufacturing a silicon-containing porous ceramic fired body according to the embodiment of the present invention has a cross-sectional shape of an equilateral n-sided polygon, an n-sided polygon, or a shape having a straight portion and/or a curved portion obtained by chamfering in at least one corner portion of any of these polygons.

Preferably, in the method for manufacturing a silicon-containing porous ceramic fired body according to the embodiment of the present invention, the firing furnace is a continuous firing furnace designed to continuously fire multiple objects to be fired while conveying the objects to be fired.

The continuous firing furnace enables continuous firing of multiple objects to be fired, which is likely to increase the manufacturing efficiency.

Hereinafter, the carbon heater of the embodiment of the present invention is described in detail. The present invention, however, is not limited to the following structures, and appropriate changes may be made without departing from the scope of the present invention.

The carbon heater of the embodiment of the present invention is a carbon heater used to fire a silicon-containing material in a non-oxidizing atmosphere, including a cross-sectional shape of a substantially n-sided polygon, wherein n represents any one of 3 to 8.

The carbon heater of the embodiment of the present invention has a cross-sectional shape of a substantially n-sided polygon, wherein n is any one of 3 to 8, more preferably any one of 3 to 6, and still more preferably 3 or 4.

A carbon heater having a cross-sectional shape of a substantially n-sided polygon has a longer peripheral length (larger surface area) than a carbon heater having a cross-sectional shape of a circle and having the same cross-sectional area. The increase in the surface area of the carbon heater decreases the temperature of the surface of the carbon heater, and inhibits the carbon heater from emitting thermal electrons. Hence, silicification on the surface of the carbon heater can be inhibited.

The substantially n-sided polygon includes an equilateral n-sided polygon, an n-sided polygon, and a shape having a straight portion or a curved portion obtained by chamfering in at least one corner portion of any of these polygons.

The cross-sectional shape of the carbon heater of the embodiment of the present invention is preferably an equilateral n-sided polygon, an n-sided polygon, or a shape having a straight portion and/or a curved portion obtained by chamfering in at least one corner portion of any of these polygons.

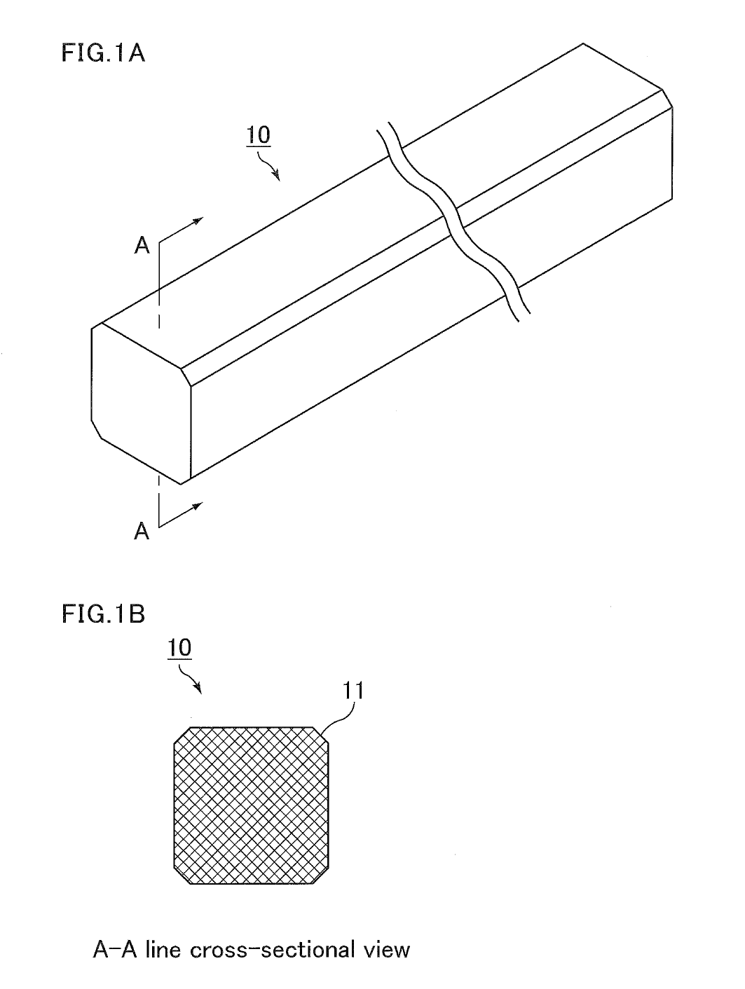

FIG. 1A is a perspective view schematically illustrating one example of the carbon heater of the embodiment of the present invention; and FIG. 1B is an A-A line cross-sectional view of FIG. 1A.

A carbon heater 10 illustrated in FIG. 1A has a square (substantially quadrangular) cross-sectional shape.

As illustrated in FIG. 1B, the carbon heater 10 has straight portions 11 formed by chamfering the corner portions thereof. Such a carbon heater having a square cross-sectional shape has a larger surface area than a carbon heater having a cross-sectional shape of a circle and having the same cross-sectional area. Therefore, the temperature of the surface of the carbon heater can be decreased without decreasing the temperature within the firing furnace. Since the decrease in the temperature of the surface of the carbon heater inhibits emission of thermal electrons, silicification on the surface of the carbon heater can be inhibited.

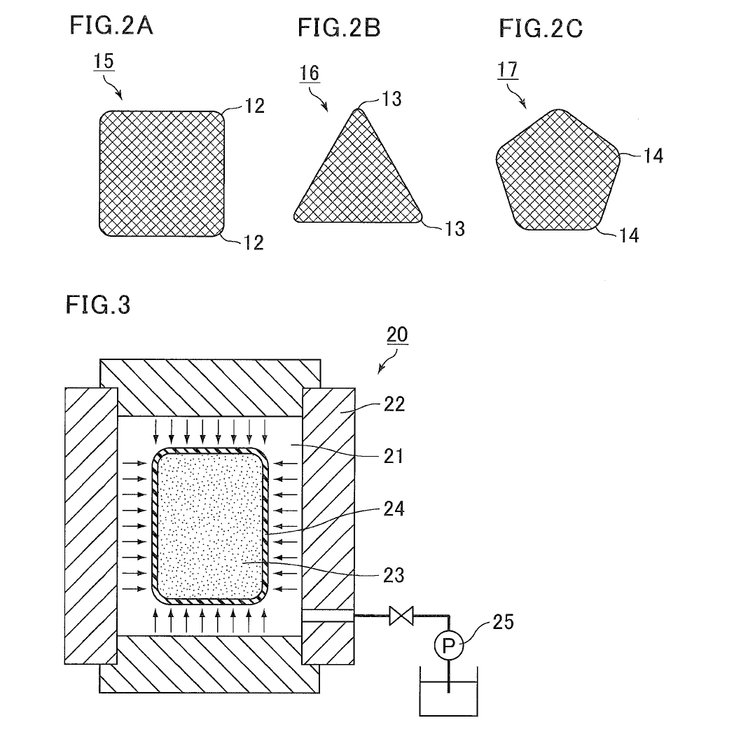

FIG. 2A is a cross-sectional view schematically illustrating another example of the carbon heater of the embodiment of the present invention; FIG. 2B is a cross-sectional view schematically illustrating yet another example of the carbon heater of the embodiment of the present invention; and FIG. 2C is a cross-sectional view schematically illustrating yet another example of the carbon heater of the embodiment of the present invention.

A carbon heater 15 illustrated in FIG. 2A has a substantially quadrangular cross-sectional shape, and has curved portions 12 formed by chamfering the corner portions. A carbon heater 16 illustrated in FIG. 2B has a substantially triangular cross-sectional shape, and has curved portions 13 formed by chamfering the corner portions. A carbon heater 17 illustrated in FIG. 2C has a substantially pentagonal cross-sectional shape, and has curved portions 14 formed by chamfering the corner portions.

As illustrated in FIG. 2A to FIG. 2C, the carbon heater of the embodiment of the present invention is preferably chamfered.

Chamfering the carbon heater enables enhancement of the mechanical strength and processability of the carbon heater.

The chamfering may form curved portions in the corner portions of a cross section perpendicular to the longitudinal direction of the carbon heater, or may form straight portions in the corner portions.

When curved portions are formed in the corner portions, each curved portion has a radius of curvature of 1 to 10 mm, preferably 1 to 5 mm. If the radius of curvature of the curved portion formed in the corner portion of a cross section perpendicular to the longitudinal direction of the carbon heater is shorter than 1 mm, enhancement of the mechanical strength and processability is insufficient, and discharge from the carbon heater cannot be sufficiently prevented. If the radius of curvature of the curved portion formed in the corner portion of a cross section perpendicular to the longitudinal direction of the carbon heater is longer than 10 mm, the cross-sectional shape is more circular and thus the periphery portion is shorter, which reduces the effect of inhibiting degradation of the heater to lengthen the life.

When straight portions are formed in the corner portions, each straight portion has a length of 1 to 10 mm, preferably 1 to 5 mm.

If the length of the straight portion formed in the corner portion of a cross section perpendicular to the longitudinal direction of the carbon heater is shorter than 1 mm, enhancement of the mechanical strength and processability is insufficient, and discharge from the carbon heater cannot be sufficiently prevented. If the length of the straight portion formed in the corner portion of a cross section perpendicular to the longitudinal direction of the carbon heater is longer than 10 mm, the cross-sectional shape is more circular and thus the periphery portion is shorter, which reduces the effect of inhibiting degradation of the heater to lengthen the life.

The cross-sectional area of the carbon heater is preferably 300 to 3000 mm², more preferably 400 to 2750 mm², and still more preferably 500 to 2500 mm².

If the cross-sectional area of the carbon heater is smaller than 300 mm², the mechanical strength is insufficient. If the cross-sectional area of the carbon heater is larger than 3000 mm², the dimension is large to lead to a large manufacturing cost. Also in this case, the electrical resistance of the carbon heater is low and thus large current flows, which results in a problem of large power loss.

In the carbon heater of the embodiment of the present invention, the density of the carbon heater is preferably 1.50 to 2.00 g/cm³, more preferably 1.70 to 1.90 g/cm³, and still more preferably 1.75 to 1.88 g/cm³.

If the density of the carbon heater is lower than 1.50 g/cm³, the mechanical strength of the carbon heater may be insufficient, while if the density is higher than 2.00 g/cm³, the manufacturing cost may increase.

Examples of the carbon constituting the carbon heater of the embodiment of the present invention include amorphous carbon, glassy carbon, and graphites. From the viewpoint of electrical properties, graphites such as anisotropic graphite and isotropic graphite are preferred, and isotropic graphite is particularly preferred.

The porosity of the carbon heater is preferably 5 to 30%. If the porosity of the carbon heater is lower than 5%, the yield of the products may decrease for the reasons related to the manufacturing method. If the porosity is higher than 30%, corrosion of the surface by high-temperature gas is likely to be promoted, and the carbon heater may be eroded in a short time to be unusable.

The porosity of the carbon heater can be measured using the Archimedes method.

Next, the method for manufacturing a carbon heater is described.

First, raw material coke is ground, so that coke powder having a particle size controlled to a predetermined size is produced. The preferred maximum particle size of the coke powder is 0.02 to 0.05 mm. Then, a binder pitch is added to the coke powder, and the resulting premixture is kneaded, so that a powder composition is prepared. From the powder composition, a molded body (object to be fired) is produced. The molded body can be produced by, for example, extrusion molding or pressure molding. Still, in order to reduce variation in the electrical properties such as electrical resistance among multiple carbon heaters, the molded body is preferably formed by cold isostatic pressing (CIP).

A cold isostatic pressing apparatus (CIP apparatus) is now described.

FIG. 3 is a cross-sectional view schematically illustrating one example of a cold isostatic pressing apparatus.

A cold isostatic pressing apparatus 20 includes a rubber mold 24 enclosing a powder composition 23; a pressure vessel 22 housing a pressurizing medium (fluid) 21 (e.g. water) and the rubber mold 24; and a pump 25 for pressurizing the rubber mold 24 (and the powder composition 23) via the pressurizing medium 21. The pressurizing medium 21 pressurized by the pump 25 pressurizes the entire surface of the rubber mold 24 with a uniform pressure. Thereby, the powder composition 23 enclosed in the rubber mold 24 is compressed with a uniform pressure, so that a molded body having a shape defined by the rubber mold 24 is formed. The porosity of the molded body of the powder composition 23 can be controlled by controlling the pressure to be added. Firing the molded body produces a carbon sintered body in which the crystal particles are randomly oriented, and it is possible to reduce variation in electrical properties such as electrical resistance among such carbon heaters. The apparatus also easily produces carbon sintered bodies with porosities within the preferred range. Such a carbon sintered body with randomly oriented crystal particles is isotropic graphite.

The pressure to be added by the CIP apparatus is about 1000 kgf/cm². The molded body may have any shape such as a carbon heater shape or a block shape, and a block-shaped molded body may be cut into a carbon heater shape before or after being fired as described later.

The powder composition is formed into a molded body (object to be fired) by the above pressure.

The molded body is then fired at a relatively high temperature (first temperature) in an inert atmosphere, so that a sintered body (carbon sintered body) made of a carbon material is formed. The carbon sintered body is further fired at a temperature (second temperature) higher than the first temperature in an inert atmosphere. Thereby, the carbon of the sintered body is graphitized, so that a crude graphite body made of graphite is generated. The crude graphite body is trimmed into the carbon heater of the embodiment of the present invention.

The first temperature and the second temperature are respectively about 1000° C. and about 3000° C., for example.

Hereinafter, the firing furnace of the embodiment of the present invention is described in detail.

The firing furnace of the embodiment of the present invention includes a power source; a housing; a firing chamber arranged in the housing; and a carbon heater that is arranged in the housing and connected to the power source, the carbon heater having a cross-sectional shape of a substantially n-sided polygon, wherein n represents any one of 3 to 8.

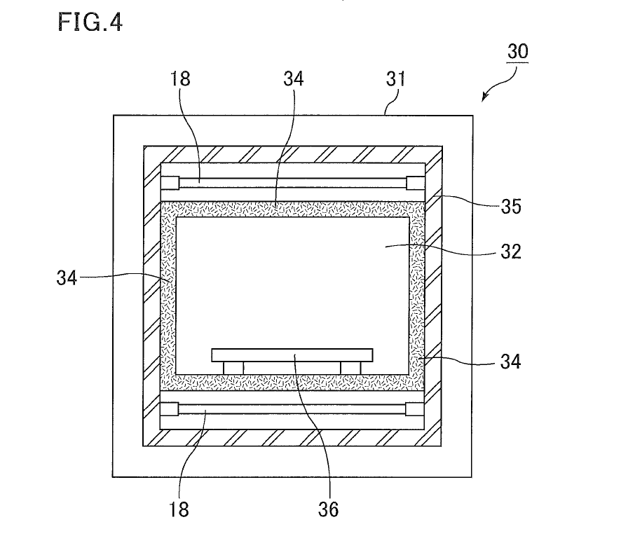

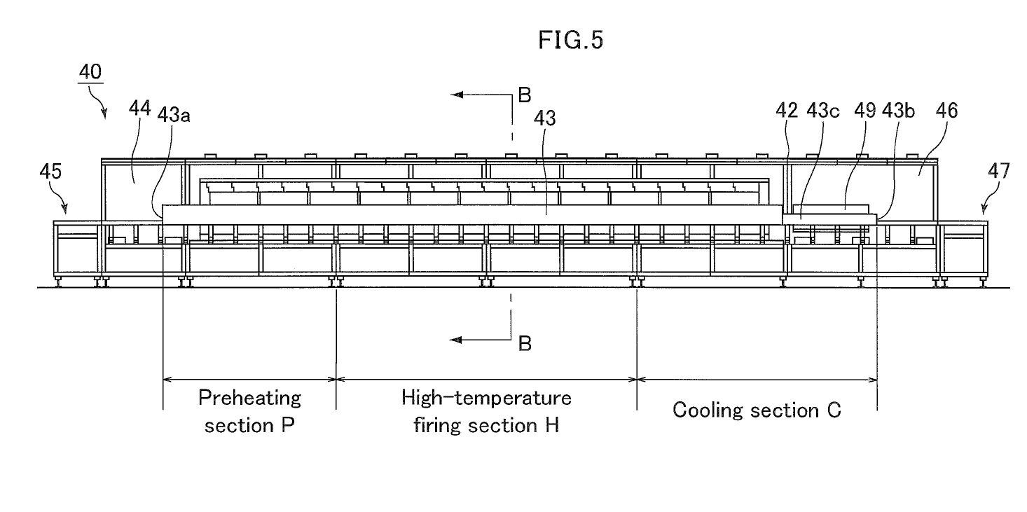

FIG. 4 is a cross-sectional view schematically illustrating the inside of the firing furnace of the embodiment of the present invention.

A firing furnace 30 illustrated in FIG. 4 includes a housing 31, a firing chamber 32 arranged in the housing 31, and multiple carbon heaters 18 arranged in the housing 31.

Here, the carbon heaters 18 are each the carbon heater of the embodiment of the present invention described above.

The firing furnace 30 further includes a power source (not illustrated) that supplies electric power to the carbon heaters 18.

The power source may be arranged at any position relative to the housing 31, but is preferably arranged outside the housing 31.

The firing chamber 32 is defined by a furnace wall 34 which is preferably formed from a high heat resistant material such as carbon.

The firing chamber 32 includes, in the bottom portion, a supporting table 36 configured to receive objects to be fired.

Between the housing 31 and the furnace wall 34, a heat insulating layer 35 formed from a material such as carbon fibers is preferably formed. This layer is formed to prevent metallic components of the housing 31 from being degraded and damaged by the heat from the firing chamber 32.

The multiple carbon heaters 18 are preferably arranged on the upper side and the lower side of the firing chamber 32, i.e., arranged to sandwich the object to be fired within the firing chamber 32.

The number of the carbon heaters 18 arranged on the upper side and the lower side of the firing chamber 32 is not particularly limited.

Also, the carbon heaters 18 may be arranged at any positions within the firing furnace, but are preferably arranged outside the furnace wall 34. If the multiple carbon heaters 18 are arranged outside the furnace wall 34, the entire furnace wall 34 is heated first, and thus the temperature within the firing chamber 32 can be uniformly raised.

Since the firing furnace of the embodiment of the present invention includes the carbon heater of the embodiment of the present invention as described above, the firing temperature is stable and the lives of the carbon heaters are lengthened, which enables reduction in the manufacturing cost and driving cost.

The firing furnace of the embodiment of the present invention may be a continuous firing furnace designed to continuously fire multiple objects to be fired while conveying the objects to be fired.

A continuous firing furnace, compared to a batch firing furnace, can greatly increase the productivity of a silicon-containing porous ceramic fired body in a mass production.

In the following, the continuous firing furnace is described.

FIG. 5 is a front view schematically illustrating one example of a continuous firing furnace.

A continuous firing furnace 40 illustrated in FIG. 5 includes a horizontally long body frame 42. In a large part of the body frame 42 except for a carry-in port 45 and a carry-out port 47, a tubular firing chamber 43 made of a heat resistant material is horizontally held. An entry purge chamber 44 is provided near an entry 43a of the firing chamber 43. The carry-in port 45 is provided on the front side relative to the entry purge chamber 44, i.e., on the left side in FIG. 5. The firing chamber 43 includes a rear end portion 43c where a cooling jacket 49, which is a cooling device, is provided. The firing chamber 43 also includes an exit 43b near which an exit purge chamber 46 is provided. The carry-out port 47 is provided on the rear side relative to the exit purge chamber 46, i.e., on the right side in FIG. 5.

In the firing chamber 43, a conveying system adapted to convey an object to be fired is laid such that by driving the conveying system, the object to be fired is carried from the entry 43a to the exit 43b, i.e., from the left side to the right side in FIG. 5.

The region of the continuous firing furnace 40 in which the firing chamber 43 is held is divided into a preheating section P, a high-temperature firing section H, and a cooling section C in the started order from the left in FIG. 5.

The preheating section P performs a preheating step of raising the temperature of the object to be fired from room temperature to a preheating temperature of 1500° C. to 2000° C.

The high-temperature firing section H performs a high-temperature firing step of raising the temperature of the object to be fired from the preheating temperature to a firing temperature of 2000° C. to 2300° C., and maintaining the temperature of the object to be fired at the firing temperature.

The cooling section C performs a cooling step of cooling the object to be fired having been subjected to the high-temperature firing step to room temperature.

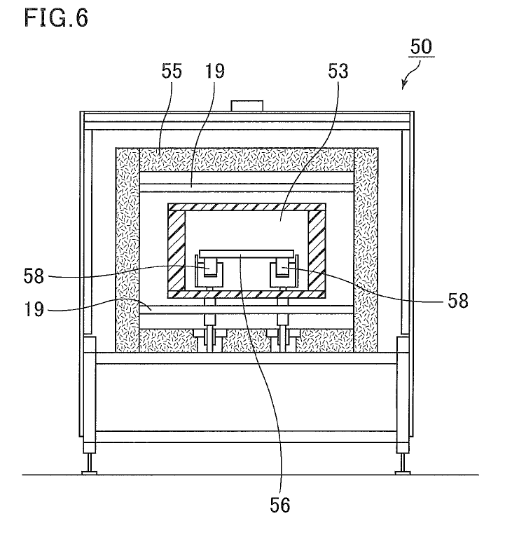

FIG. 6 is a B-B line cross-sectional view of a high-temperature firing section of the continuous firing furnace illustrated in FIG. 5.

The high-temperature firing section H illustrated in FIG. 6 includes a heat insulating layer 55, a firing chamber 53 arranged at the center of the heat insulating layer 55, and two lines of rollers 58 constituting the conveying system in the bottom portion of the firing chamber 53.

On the rollers 58, a supporting table 56 configured to receive objects to be fired is arranged.

A large number of the rollers 58 are arranged in the longitudinal direction (the lateral direction in FIG. 5) of the continuous firing furnace. When the rollers 58 are driven, the objects to be fired and the supporting table 56 are carried together within the firing chamber 53.

Carbon heaters 19 illustrated in FIG. 6 each correspond to the carbon heater of the embodiment of the present invention.

The multiple carbon heaters 19 are preferably arranged on the upper side and the lower side of the firing chamber 53, i.e., arranged to sandwich the object to be fired within the firing chamber 53.

The number of the carbon heaters 19 arranged on the upper side and the lower side of the firing chamber 53 is not particularly limited.

In the following, the method for manufacturing a silicon-containing porous ceramic fired body according to the embodiment of the present invention is described.

The method for manufacturing a silicon-containing porous ceramic fired body according to the embodiment of the present invention includes the steps of: producing an object to be fired from a composition that contains a silicon-containing ceramic powder; and firing the object to be fired in a non-oxidizing atmosphere in a firing furnace that includes: a power source; a housing; a firing chamber arranged in the housing; and a carbon heater that is arranged in the housing and connected to the power source, the carbon heater having a cross-sectional shape of a substantially n-sided polygon, wherein n represents any one of 3 to 8.

The method for manufacturing a silicon-containing porous ceramic fired body according to the embodiment of the present invention utilizes the firing furnace that includes: a power source; a housing; a firing chamber arranged in the housing; and a carbon heater that is arranged in the housing and connected to the power source, the carbon heater having a cross-sectional shape of a substantially n-sided polygon, wherein n represents any one of 3 to 8. Since the carbon heater has a cross-sectional shape of a substantially n-sided polygon, the carbon heater is inhibited from emitting thermal electrons, and thus silicification on the surface of the carbon heater can be inhibited. Accordingly, the life of the carbon heater is lengthened, and the cross-sectional area of the carbon heater is not likely to change, and thereby the temperature within the firing furnace can be easily maintained at a constant temperature.

As a result, the qualities of the silicon-containing porous ceramic fired bodies are not likely to change, so that the manufacturing cost can be suppressed.

In the following, each step constituting the method for manufacturing a silicon-containing porous ceramic fired body of the embodiment of the present invention is described.

First, the step of producing an object to be fired from a composition containing silicon-containing ceramic powder is described.

In this step, a wet mixture is prepared by mixing components such as at least two kinds of silicon-containing ceramic powders with different average particle sizes, an organic binder, a liquid plasticizer, a lubricant, and water.

Then, the wet mixture is molded into a ceramic molded body.

The ceramic molded body is dried, and degreased at a predetermined temperature to remove organic substances in the molded body under heat, so that an object to be fired is produced.

Examples of the silicon-containing ceramic powders include nitride ceramics such as aluminum nitride, silicon nitride, boron nitride, and titanium nitride; carbide ceramics such as silicon carbide, zirconium carbide, titanium carbide, tantalum carbide, and tungsten carbide; oxide ceramics such as alumina, zirconia, cordierite, mullite, and silica; mixtures of firing materials, such as a complex of silicon and silicon carbide; and oxide ceramics and non-oxide ceramics containing multiple kinds of metal elements, such as aluminum titanate.

When an object to be fired containing any of these silicon-containing ceramic powders is fired, SiO gas is generated.

The step of firing the object to be fired is described.

The object to be fired is fired in the firing furnace described above. The conditions for the firing can appropriately be the conditions conventionally employed in production of a ceramic fired body.

Here, when, for example, the object to be fired containing a silicon-containing porous ceramic is fired in an argon atmosphere at 2190° C. to 2210° C. for 0.1 to 5 hours, SiO gas is generated.

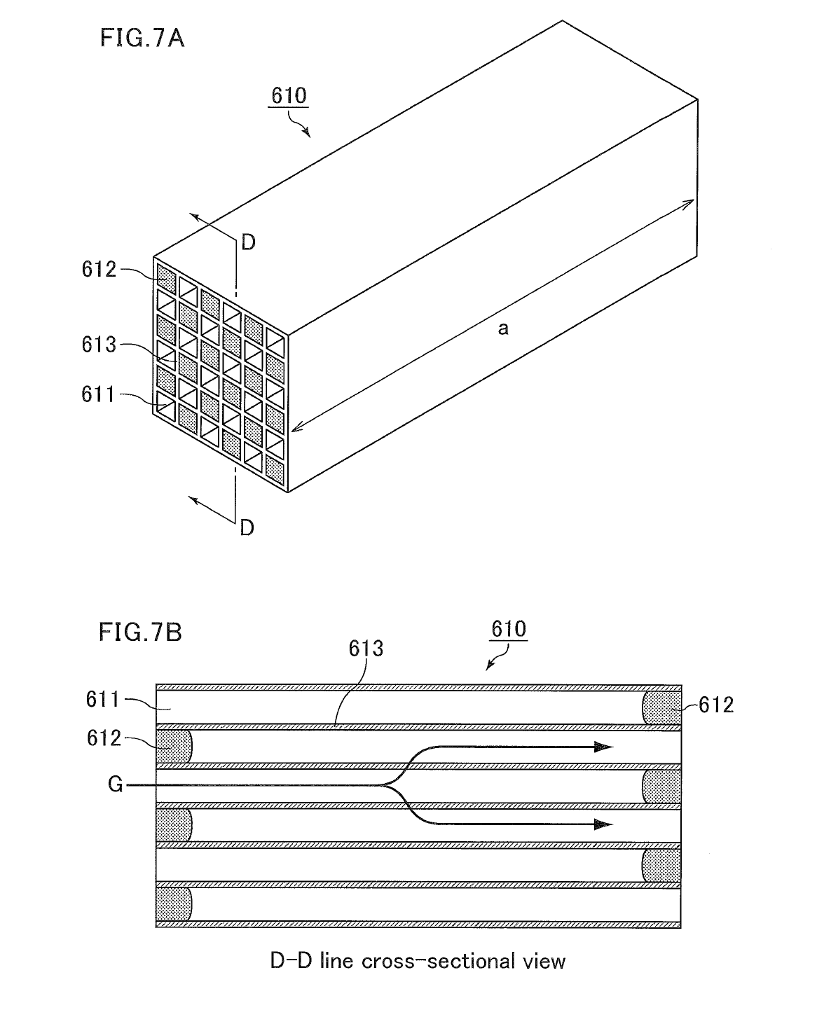

In the method for manufacturing a silicon-containing porous ceramic fired body according to the embodiment of the present invention, the resulting ceramic fired body may be of any kind, and may be, for example, a honeycomb fired body as illustrated in FIG. 7A and FIG. 7B.

A honeycomb fired body is manufactured by producing a honeycomb molded body, which is an object to be fired, degreasing the molded body, and firing the degreased body.

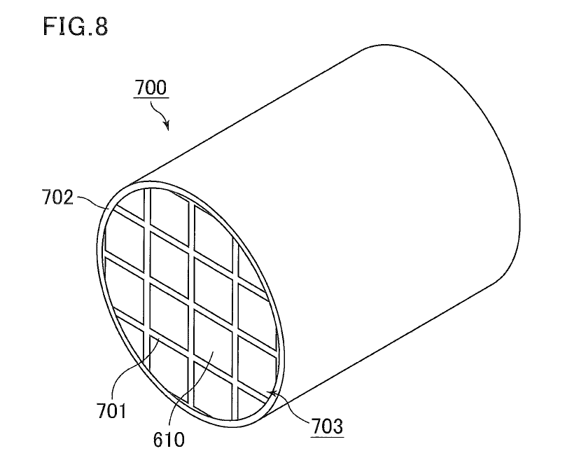

Honeycomb fired bodies produced can be used alone, but may also be combined with one another via an adhesive, and the resulting product may be processed into a predetermined shape, so that a honeycomb structured body as illustrated in FIG. 8 which is configured to function as a filter can be manufactured.

The honeycomb fired body and the honeycomb structured body are described below.

FIG. 7A is a perspective view schematically illustrating one example of a honeycomb fired body, and FIG. 7B is a D-D line cross-sectional view of FIG. 7A.

FIG. 8 is a perspective view schematically illustrating one example of a honeycomb structured body.

In a honeycomb fired body 610 illustrated in FIG. 7A and FIG. 7B, multiple cells 611 are arranged in parallel with each other with cell walls 613 therebetween in the longitudinal direction (in FIG. 7A, the direction “a”), and either one end of each cell 611 is sealed with a sealing material 612. Therefore, exhaust gas G flowing into one cell 611 of which one end is open passes through the cell walls 613 separating the cells 611, and flows out from other cells 611 of each of which the other end is open.

The cell walls 613 therefore function as filters that capture substances such as PM.

On the honeycomb fired body, a catalyst that purifies exhaust gases may be supported. The catalyst to be supported is preferably a noble metal such as platinum, palladium, and rhodium, and more preferably platinum. Other examples of the catalyst include alkali metals such as potassium and sodium, and alkaline earth metals such as barium. These catalysts may be used alone or in combination. With these catalysts supported, PM is likely to be removed by firing, and purification of toxic exhaust gases is possible.

When either one end of each cell 611 is sealed, it is preferred that in a view from one end of the honeycomb fired body 610, end-sealed cells and end-open cells are alternately arranged.

In an exhaust gas treating body, no sealing material may be provided to the cells and the ends of the cells may not be sealed. In this case, the exhaust gas treating body functions as a catalyst supporting carrier adapted to purify toxic gas components in exhaust gases, such as CO, HC, and NOx.

The cross-sectional shape obtained by cutting a honeycomb fired body in perpendicular to the longitudinal direction of the honeycomb fired body may be any shape such as a substantially circular shape, a substantially oval shape, or a substantially polygonal shape such as a substantially triangular shape, a substantially quadrangular shape, a substantially pentagonal shape, or a substantially hexagonal shape.

Each cell 611 constituting the honeycomb fired body may have a substantially polygonal shape such as a substantially triangular shape, a substantially quadrangular shape, a substantially pentagonal shape, or a substantially hexagonal shape, or may be a substantially circular shape or a substantially oval shape. The honeycomb fired body 610 may be formed from cells with different cross-sectional shapes in combination.

A honeycomb structured body 700 illustrated in FIG. 8 includes a ceramic block 703 in which multiple honeycomb fired bodies 610 each being made of porous silicon carbide and having a shape as illustrated in FIG. 7A and FIG. 7B are bonded with sealing material layers (adhesive layers) 701 therebetween. On the outer periphery of the ceramic block 703, a sealing material layer (outer peripheral coating layer) 702 is formed.

In the following, the effects of the carbon heater, the heater unit, the firing furnace, and the method for manufacturing a silicon-containing porous ceramic fired body according to the embodiment of the present invention are described.

(1) The carbon heater of the embodiment of the present invention has a cross-sectional shape of a substantially n-sided polygon, wherein n represents any one of 3 to 8. Thus, the carbon heater has a larger surface area than a carbon heater having a cross-sectional shape of a circle. The temperature of the surface of the carbon heater can be decreased without decreasing the temperature within the firing furnace, whereby degradation of the carbon heater can be inhibited.
(2) Since degradation of the carbon heater of the embodiment of the present invention is small, change in the cross-sectional area is also small. Accordingly, the temperature within the firing furnace can be stably maintained, and variation in the quality of the objects to be fired can be reduced.
(3) Since the heater unit of the embodiment of the present invention can inhibit degradation of the carbon heaters, the heaters of the heater unit each exhibit a lengthened life.
(4) The firing furnace of the embodiment of the present invention can inhibit degradation of the carbon heaters, even at high temperatures in the presence of a silicon-containing compound. The firing furnace is therefore suitable for manufacture of a silicon-containing porous ceramic fired body.
(5) Since the method for manufacturing a silicon-containing porous ceramic fired body according to the embodiment of the present invention can inhibit degradation of the carbon heaters, the method is likely to contribute to lengthened lives of the heaters, and the temperature within the furnace is not likely to change. Accordingly, the manufacturing cost can be reduced, and variation in the quality of the ceramic fired bodies can be reduced.

### EXAMPLES

Hereinafter, specific examples of the embodiment of the present invention are described. The present invention, however, is not limited to these examples.

### Example 1

### Manufacture of Carbon Heater

### (1) Coke Grinding Step

Raw material coke was ground into coke powder having a D90 of 0.35 mm.

### (2) Kneading Step

A binder pitch was added to the coke powder, and the resulting premixture was kneaded into a powder composition.

### (3) Molding Step

The powder composition was molded into a predetermined size by the CIP, whereby a molded body (object to be fired) was obtained. The pressure during the molding was 1000 kgf/cm².

### (4) Firing Step

The molded body was heated in an inert atmosphere at 850° C. for 8 hours, so that a fired body was obtained.

### (5) Graphitization Step

The fired body was heated in an inert atmosphere for at 2900° C. for 6 hours, and thereby isotropic graphite having a dimension of 300×600×1200 mm was obtained.

### (6) Processing Step

The isotropic graphite was cut into pieces having a rectangular pillar shape with a size of 44.5×42.5×1050 mm (cross-sectional shape: a 44.5×42.5 mm rectangle, including curved portions each having a radius of curvature of 5 mm in the four corner portions; cross-section area: 1871 mm²). Thereby, carbon heaters of Example 1 were obtained. The carbon heaters of Example 1 had a density of 1.75, a specific resistance of about 1350 μΩcm, and a porosity of 15%.

### Comparative Example 1

Carbon heaters of Comparative Example 1 were obtained in the same manner as in Example 1, except that the shape of the carbon heaters in the processing step (6) was a round pillar shape with a diameter of 48.3 mm. The cross-sectional area of the carbon heaters of Comparative Example 1 was 1830 mm², and the parameters, namely the density, the specific resistance, and the porosity, of the heater were the same as those of the carbon heaters of Example 1.

### (Degradation Test)

Two of the carbon heaters arranged in the high-temperature firing section H in the continuous firing furnace illustrated in FIG. 5 were replaced by the carbon heaters of Example 1. The furnace was operated in an argon atmosphere at about 2200° C. for successive 104 days. The continuous firing furnace was stopped, and the carbon heaters of Example 1 were taken out. The lengths of the sides of the heaters were measured and compared to the lengths before the operation, so that the degradation rate of the carbon heaters were determined.

Also, two of the carbon heaters arranged in the high-temperature firing section H in the continuous firing furnace illustrated in FIG. 5 were replaced by the carbon heaters of Comparative Example 1. The furnace was operated in an argon atmosphere at about 2200° C. for successive 74 days. The continuous firing furnace was stopped, and the carbon heaters of Comparative Example 1 were taken out. The diameters of the heaters were measured and compared to the diameters before the operation, so that the degradation rate of the carbon heaters were determined. The results of the example and the comparative example are shown in Table 1.

The degradation rate (%) is a value showing the amount of reduction in the cross-sectional area of the carbon heater after the degradation test compared to that before the degradation test, and is represented by the following formula (V).

Degradation rate (%)=(cross-sectional area before operation)−(cross-sectional area after operation))/(cross-sectional area before operation)×100 (V)

A larger value of the degradation rate indicates larger degradation of the carbon heater.

TABLE 1

| | | | | | Length of side or | Cross-sectional | |
|---|---|---|---|---|---|---|---|
| | Length of side or | | | | diameter of cross | area after | Degradation rate |
| | diameter of cross | Cross-sectional | Surface area | Predetermined | section after opera- | operation for | after operation for |
| | section before | area before | before | number of days | tion for predetermin- | predetermined | predetermined |
| | operation | operation | operation * | for operation | ed number of days | number of days | number of days |
| | [mm] | [mm²] | [mm²] | [day] | [mm] | [mm²] | [%] |
| Example 1 | 44.5 × 42.5 | 1871 | 173750 | 104 | 43.3 × 41.3 | 1768.0 | 5.5 |
| Comparative | 48.3 | 1830 | 159260 | 74 | 46.8 | 1719.0 | 6.1 |
| Example 1 | | | | | | | |

The degradation rate in Example 1 was 5.5% even though the number of days for operation was 104 days, while the degradation rate in Comparative Example 1 was 6.1% even though the number of days for operation was 74 days. These results show that with use of the carbon heater of the embodiment of the present invention, emission of thermal electrons can be inhibited, and thus silicification on the surface of the carbon heater can be inhibited.

Obviously, numerous modifications and variations of the present invention are possible in light of the above teachings. It is therefore to be understood that within the scope of the appended claims, the invention may be practiced otherwise than as specifically described herein.

1. A carbon heater to fire a silicon-containing material in a non-oxidizing atmosphere, comprising:
a cross-sectional shape of a substantially n-sided polygon, n representing any one of 3 to 8.

2. The carbon heater according to claim 1,
wherein n represents any one of 3 to 6.

3. The carbon heater according to claim 1,
wherein n represents 3 or 4.

4. The carbon heater according to claim 1,
wherein the carbon heater has a cross-sectional shape of an equilateral n-sided polygon, an n-sided polygon, or a shape having at least one of a straight portion and a curved portion obtained by chamfering in at least one corner portion of any of the equilateral n-sided polygon and the n-sided polygon.

5. The carbon heater according to claim 4,
wherein the chamfering is performed to provide a curved portion having a radius of curvature of about 1 mm to about 10 mm in a corner portion of a cross section perpendicular to a longitudinal direction of the carbon heater.

6. The carbon heater according to claim 4,
wherein the chamfering is performed to provide a straight portion having a length of about 1 mm to about 10 mm in a corner portion of a cross section perpendicular to a longitudinal direction of the carbon heater.

7. The carbon heater according to claim 1,
wherein the carbon heater has an electrical resistance of about 0.003Ω to about 0.03 Ω.

8. The carbon heater according to claim 1,
wherein the carbon heater has a cross-sectional area of about 300 mm² to about 3000 mm².

9. The carbon heater according to claim 1,
wherein the carbon heater has a density of about 1.50 g/cm³ to about 2.00 g/cm³.

10. The carbon heater according to claim 1,
wherein the carbon heater has a porosity of about 5% to about 30%.

11. A heater unit to fire a silicon-containing material in a non-oxidizing atmosphere, comprising:
a power source; and
a carbon heater connected to the power source, the carbon heater having a cross-sectional shape of a substantially n-sided polygon, n representing any one of 3 to 8.

12. The heater unit according to claim 11,
wherein the carbon heater has a cross-sectional shape of an equilateral n-sided polygon, an n-sided polygon, or a shape having at least one of a straight portion and a curved portion obtained by chamfering in at least one corner portion of any of the equilateral n-sided polygon and the n-sided polygon.

13. A firing furnace to fire a silicon-containing material in a non-oxidizing atmosphere, comprising:
a power source;
a housing;
a firing chamber arranged in the housing; and
a carbon heater arranged in the housing and connected to the power source, the carbon heater having a cross-sectional shape of a substantially n-sided polygon, n representing any one of 3 to 8.

14. The firing furnace according to claim 13,
wherein the carbon heater has a cross-sectional shape of an equilateral n-sided polygon, an n-sided polygon, or a shape having at least one of a straight portion and a curved portion obtained by chamfering in at least one corner portion of any of the equilateral n-sided polygon and the n-sided polygon.

15. A method for manufacturing a silicon-containing porous ceramic fired body, comprising:
producing an object to be fired from a composition that contains a silicon-containing ceramic powder; and
firing the object to be fired in a non-oxidizing atmosphere in a firing furnace comprising:
a power source;
a housing;
a firing chamber arranged in the housing; and
a carbon heater arranged in the housing and connected to the power source, the carbon heater having a cross-sectional shape of a substantially n-sided polygon, n representing any one of 3 to 8.

16. The method according to claim 15,
wherein the firing furnace comprises a continuous firing furnace designed to continuously fire multiple objects to be fired while conveying the multiple objects to be fired.

17. The method according to claim 15,
wherein the carbon heater has a cross-sectional shape of an equilateral n-sided polygon, an n-sided polygon, or a shape having at least one of a straight portion and a curved portion obtained by chamfering in at least one corner portion of any of the equilateral n-sided polygon and the n-sided polygon.

18. The carbon heater according to claim 2,
wherein n represents 3 or 4.

19. The carbon heater according to claim 2,
wherein the carbon heater has a cross-sectional shape of an equilateral n-sided polygon, an n-sided polygon, or a shape having at least one of a straight portion and a curved portion obtained by chamfering in at least one corner portion of any of the equilateral n-sided polygon and the n-sided polygon.

20. The carbon heater according to claim 3,
wherein the carbon heater has a cross-sectional shape of an equilateral n-sided polygon, an n-sided polygon, or a shape having at least one of a straight portion and a curved portion obtained by chamfering in at least one corner portion of any of the equilateral n-sided polygon and the n-sided polygon.
